(19) United States
(12) Patent Application Publication
(10) Pub. No.: US 2011/0042501 A1
(43) Pub. Date: Feb. 24, 2011

(54) WINDING APPARATUS FOR ICE FISHING TIP-UPS

(76) Inventor: Guilford Thorsen, Salem, WI (US)

Correspondence Address: James Ray & Associates, 2640 Pitcairn Road, Monroeville, PA, 15146, US

(21) Appl. No.: 12/858,850

(22) Filed: Aug. 18, 2010

Related U.S. Application Data
(60) Provisional application No. 61/235,254, filed on Aug. 19, 2009.

(51) Int. Cl. A01K 89/015; G05G 1/10

(52) U.S. Cl. 242/283; 74/545

(57) ABSTRACT

The present invention is a tool used to assist fishermen in winding their tip-ups. The tool may be composed of metal and include a handle. There may be a deep well socket in the center with two notches cut out. These notches may connect to a fishing reel like handle. The socket section may attach to a T-part of the tip-up. Once the tool is on the tip-up, simply wind the handle around to wind up the fishing line.

### CROSS-REFERENCE TO RELATED APPLICATIONS

This application is related to and claims priority from provisional patent application 61/235,254 filed Aug. 19, 2009 and is herein incorporated by reference.

### FIELD OF THE INVENTION

This invention generally pertains to ice fishing tip-ups. More particularly this invention pertains to tools and methods of winding ice fishing tip-ups.

### BACKGROUND OF THE INVENTION

The invention is particularly applicable to tip-ups for ice fishing and will be described with particular reference thereto. However, it will be appreciated by those skilled in the art that the invention has broader applications and may also be adapted for use in other applications.

Currently, there is no easy way to wind up a tip-up when ice fishing. Fishermen must take off their gloves in order to get a grip on the line. This is not only inconvenient, but also uncomfortable due to the low temperatures. It can be difficult to get a tight wind on the spool when using the hands. After catching a fish, the line will often be out 20 feet to 30 feet. It can be a hassle trying to get this line back on the spool. A more effective method is needed.

### SUMMARY OF THE INVENTION

The present invention provides a quick and efficient method and device for winding tip-ups. This device is ideal for use by ice fishermen who are looking for an easier way to tightly wind up the spool on the tip-up. The device eliminates the need to manually wind up excess line, which can be time-consuming and inconvenient. This tool will enable a fisherman to wind the line in an organized fashion in a short amount of time.

The present invention is a tool used to assist fishermen in winding their tip-ups. The tool may be composed of metal and include a handle. There may be a deep well socket in the center with two notches cut out. These notches may connect to a fishing reel like handle. The socket section may attach to a T-part of the tip-up. Once the tool is on the tip-up, simply wind the handle around to wind up the fishing line. The tool may be approximately 2″ by 3″ by 2.5″ with a diameter of approximately 7/16″. The device may be aluminum with a black handle. The exact specifications may vary.

### OBJECTS OF THE INVENTION

It is, therefore, one of the primary objects of the present invention to provide an ice fishing wind up tool.

Another object of the present invention is to provide an improved ice fishing wind up method.

In one embodiment the invention is a wind up tool comprising: a first shaft, a second shaft, a handle rotatably attached to a distal end of said second shaft, wherein said first shaft is attached to said second shaft. In another embodiment said first shaft comprises a deep well socket. In still another embodiment said first shaft comprises a deep well socket with at least one notch cut out of a sidewall of said deep well socket. In yet still another embodiment said first shaft comprises a deep well socket with at least two notches cut out of a sidewall of said deep well socket.

In another embodiment the invention is a wind up tool comprising: a first shaft comprising a deep well socket with at least two notches cut out of a sidewall of said deep well socket, a second shaft, a handle rotatably attached to a distal end of said second shaft, wherein said first shaft is attached to said second shaft. In still another embodiment said wind up tool is used in combination with an ice fishing tip-up.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general view of the invention with a typical ice fishing tip-up.

FIG. 2 is a detailed view of the invention.

FIG. 3 is a general view of the invention with a typical ice fishing tip-up in use.

FIG. 4 is a general view of the invention with a typical ice fishing tip-up being remove from the water.

FIG. 5 is a general view of the present invention being used to wind up an ice fishing tip-up.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

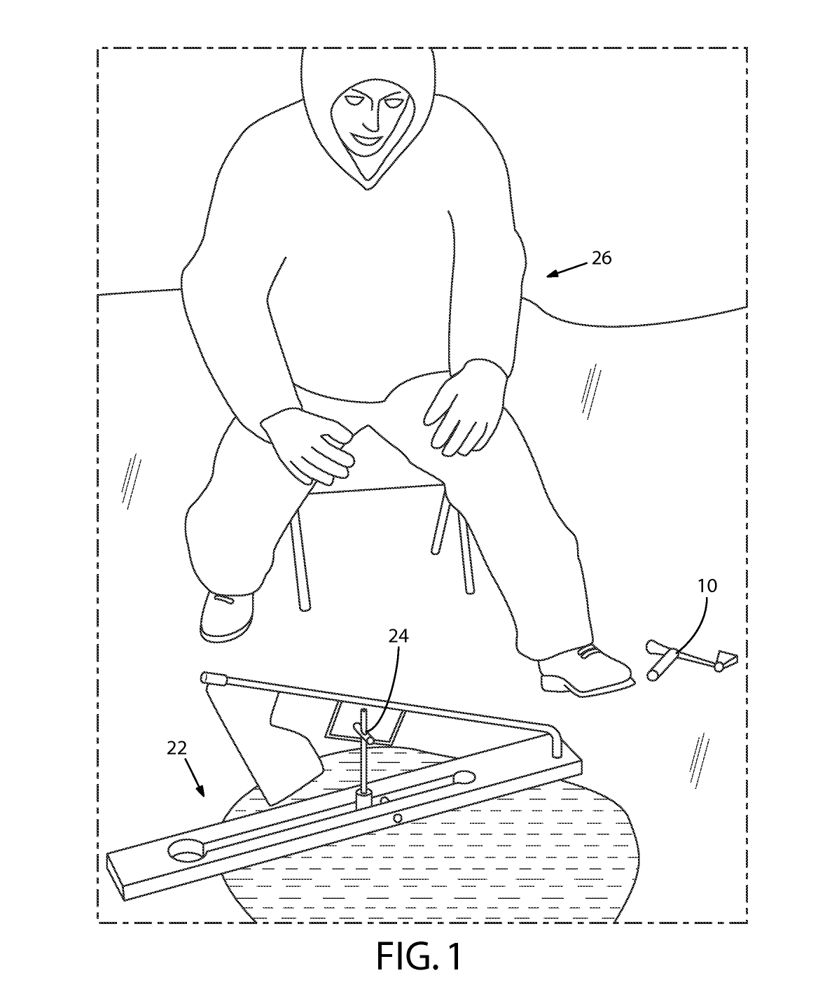

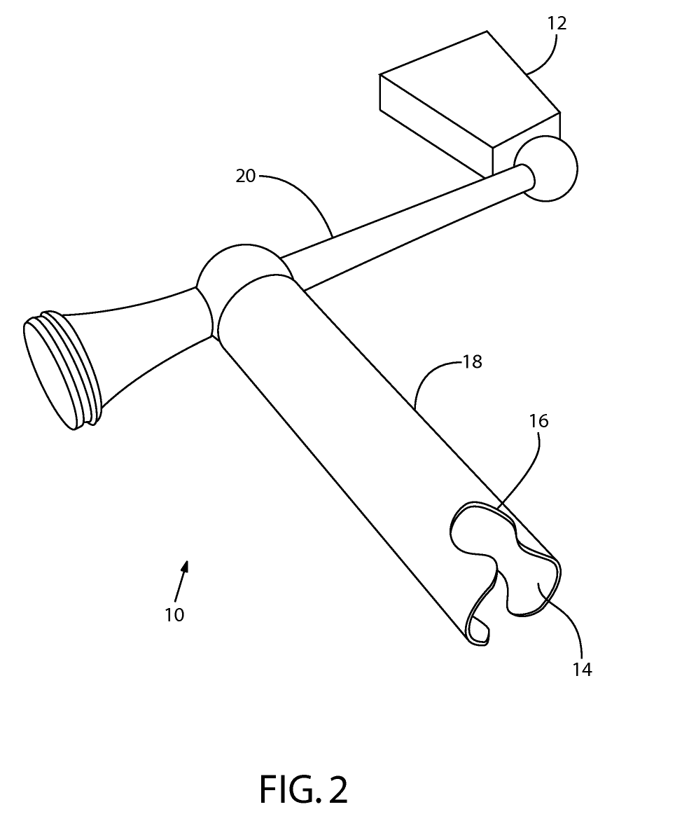

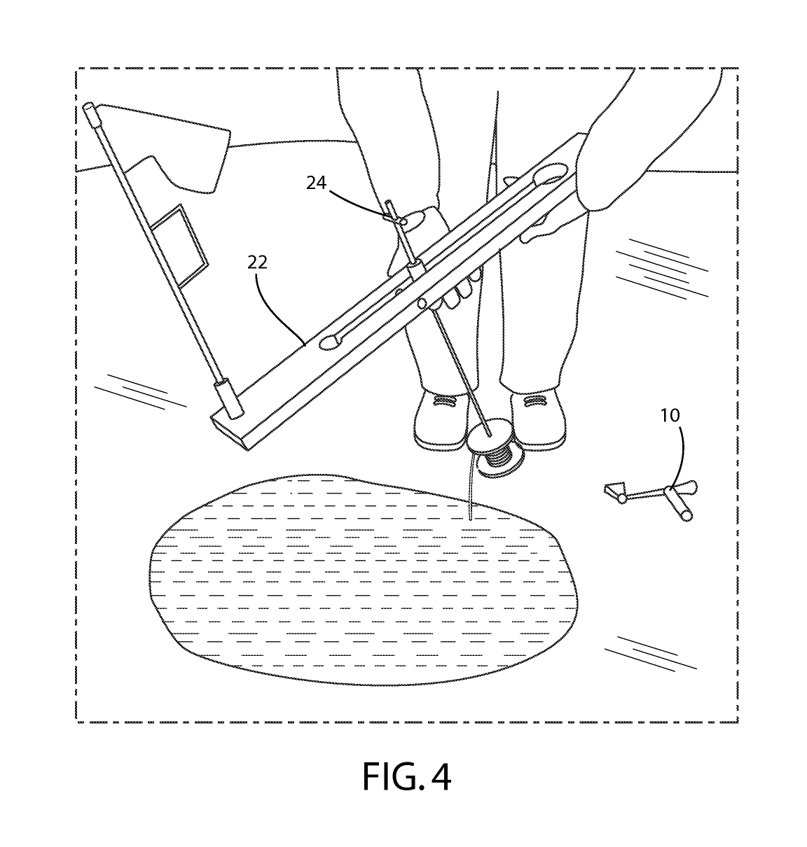

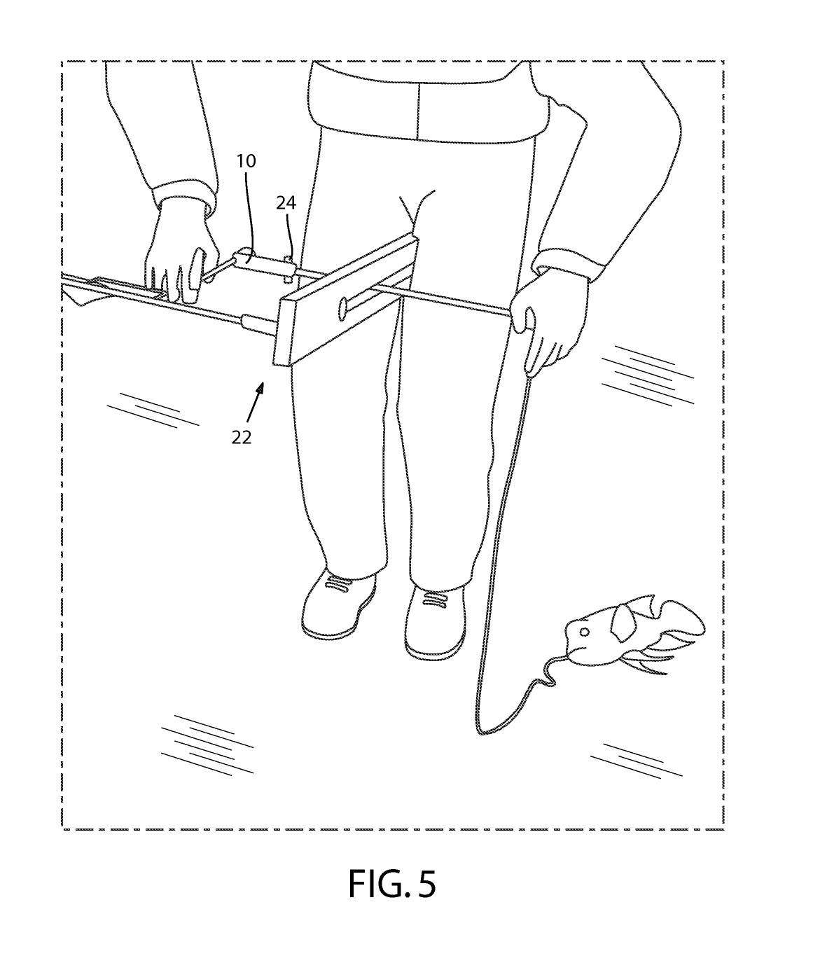

Reference is now made to FIGS. 1-5, more particularly, to FIG. 2 which is a detailed view of the present invention, a wind up tool 10. The wind up tool 10 may be comprised of metal and include a handle 12. There may be a deep well socket 14 in the main shaft 18 with two notches 16 cut out. A secondary shaft 20 may connect to a rotatable handle 12.

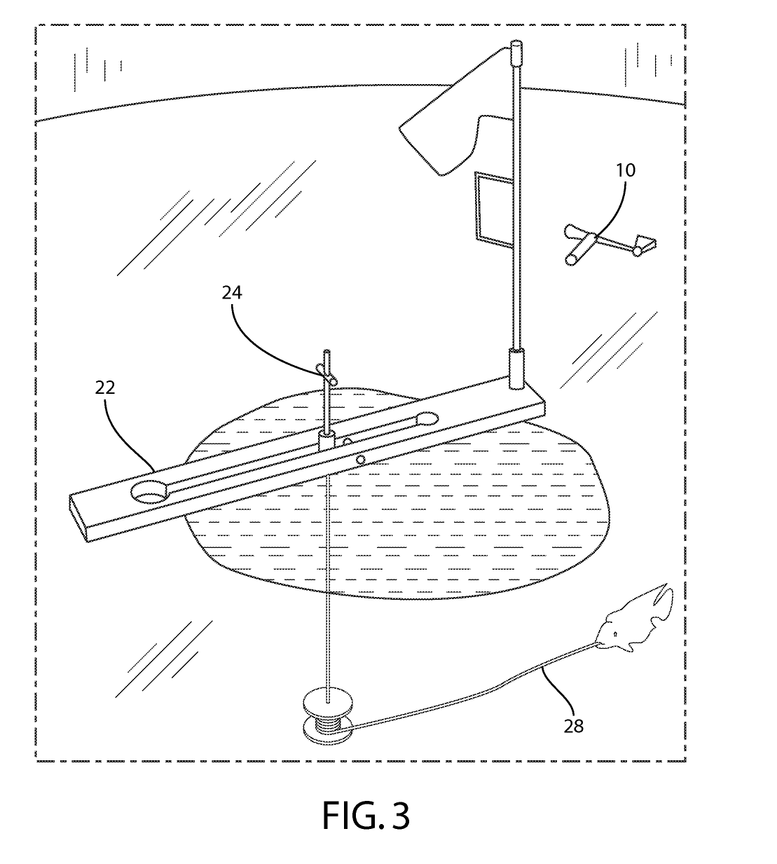

Reference now made more particularly to FIGS. 3-5, the socket 14 may mechanically couple to a T-part 24 of the tip-up 22. Once the tool 10 is coupled to the T-part 24 on the tip-up 22, a user 26 simply winds the handle 12 around to wind up the fishing line 28. The tool may be approximately 2″ by 3″ by 2.5″ with a diameter of approximately 7/16″. The device may be aluminum with a black handle.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed:

1. A wind up tool comprising:
a first shaft,
a second shaft,
a handle rotatably attached to a distal end of said second shaft,
wherein said first shaft is attached to said second shaft.

2. The wind up tool of claim 1, wherein said first shaft comprises a deep well socket.

3. The wind up tool of claim 1, wherein said first shaft comprises a deep well socket with at least one notch cut out of a sidewall of said deep well socket.

4. The wind up tool of claim 1, wherein said first shaft comprises a deep well socket with at least two notches cut out of a sidewall of said deep well socket.

5. A wind up tool comprising:
a first shaft comprising a deep well socket with at least two notches cut out of a sidewall of said deep well socket,
a second shaft,
a handle rotatably attached to a distal end of said second shaft,
wherein said first shaft is attached to said second shaft.

6. The wind up tool of claim 1, wherein said wind up tool is used in combination with an ice fishing tip-up.

7. The wind up tool of claim 5, wherein said wind up tool is used in combination with an ice fishing tip-up.
